(19) United States
(12) Patent Application Publication
(10) Pub. No.: US 2010/0275828 A1
(43) Pub. Date: Nov. 4, 2010

(54) CROSS CUT

(76) Inventors: Uwe Stein, Heinsberg (DE); Heiner Schillings, Heinsberg (DE); Stefan Nauber, Wuppertal (DE)

Correspondence Address: ST. ONGE STEWARD JOHNSTON & REENS, LLC, 986 BEDFORD STREET, STAMFORD, CT, 06905-5619, US

(21) Appl. No.: 12/771,304

(22) Filed: Apr. 30, 2010

(30) Foreign Application Priority Data
May 2, 2009 (DE) 10 2009 019 807.5

(51) Int. Cl. B63H 9/06; B32B 5/02; D03D 25/00

(52) U.S. Cl. 114/102.31; 428/292.1; 442/181

(57) ABSTRACT

Sailcloth of longitudinal direction (machine direction) including a carrier layer, an intermediate layer with several plies of laid yarn as well as a finishing layer, with the yarns being bonded under pretension with the carrier layer and the layers joined with each other, the intermediate layer includes at least three yarn layers the yarns of which being laid at an angle ranging between 55 and 125° relative to the longitudinal direction so that at angles of 60° to 120° and 240° to 300° in relation to the longitudinal direction the cloth has a stretching resistance at 1% of expansion of at least 150 Ibf (667 N).

### CROSS-REFERENCE TO RELATED APPLICATIONS

The present application claims priority of German patent application No. 10 2009 019 807.5 filed on May 2, 2009.

### FIELD OF THE INVENTION

The invention relates to a sailcloth of longitudinal direction (machine direction) comprising a carrier layer, an intermediate layer with several plies of yarn as well as a finishing layer, with the yarns being bonded under pretension with the carrier layer and the layers joined with each other.

### BACKGROUND OF THE INVENTION

When manufacturing sails, also for competition purposes, it is an essential requirement to combine quite a number of special characteristics such as low weight, good handling qualities, low permeability to wind, high tearing resistance, elasticity and similar properties. Therefore, the ultimate goal sailmakers have in mind is to create an optimized membrane for sail manufacturing which purposefully features all these characteristics.

Although known sailcloths have an extremely high stretching resistance and strength in one main direction they also offer adequate stretching resistance in other directions so that the sail made from such cloth can also be stressed or loaded in directions other than the main direction referred to. When the sail is manufactured the sailcloth is put together in segments and sailmakers always endeavor to cut the cloth in such a manner that the direction of highest stretching resistance and strength extends in the direction of the principal load lines of the sail.

In the manufacture of sails from sailcloth panels two basic methods are adopted. One is the “radial cut” method providing for sail segments or panels to be cut out of the sailcloth such that the direction of highest stretching resistance and strength satisfies the above mentioned criteria. This manufacturing method entails significant cutting waste and thus makes manufacture more costly because major portions of the sailcloth can no longer be used for sailmaking.

When employing the so-called “cross cut” method sailcloth webs are cut to size transversely to the machine direction and processed to form the individual panels of the sail which are more or less parallelly arranged in the finished sail. Cutting waste can be limited when this method is applied; however when sailcloth webs are manufactured in a customary manner the direction where maximum stretching resistance and strength occurs often does not coincide with the direction where the main load lines extend in the finished sail. Sails produced according to the cross-cut method are less expensive than those composed of radial-cut panels, but their strength and load-carrying ability are inferior to that of the latter.

To optimize the strength properties of a sail reinforcing yarns are frequently integrated into the sailcloth webs, said yarns forming their own layers between a carrier layer and a finishing layer. A carrier layer may, for example, consist of a polyester sheet, e.g. Mylar®, or a dense woven polyester fabric. When polyester sheets are used as carrier material, said sheets or film may come with a light woven polyester fabric (taffeta) laminated to its outer side. (This light taffeta material exclusively serves as mechanical protection of the film and as UV protection of the embedded fibers). Kevlar®, an aramid fiber, is often used for the layers laid between the carrier layer and finishing layer. As finishing layer a polyester sheet is usually employed, but a woven fabric may as well be used for this purpose. The yarns laid between the carrier layer and the finishing layer are arranged in a more or less regular pattern of parallel strands which are extending at various angles in relation to the longitudinal direction (machine direction) of the sailcloth.

Sails reinforced by yarns laid in the sail membrane are for instance known from DE 39 28 312 A1. The composed sails described in that publication consist of a carrier layer of a woven fabric, a finishing layer of a sheet material, and of reinforcing yarns laid in between in an adhesive bed, said yarns may, for example, be made of aramid fibers (Kevlar®). The yarns of the intermediate layer are arranged parallelly to each other and extend transverse to reinforcing threads integrated into the carrier layer. The reinforcing yarns located in the carrier layer run in the main loading direction of the relevant cloth segment in the finished sail. All in all, a pattern is obtained that consists of reinforcing yarns extending vertically to each other in the sailcloth.

As proposed in U.S. Pat. No. 7,305,127 B2 a sailcloth has at least three yarn layers within one carrier layer and one finishing layer, said yarn layers being laid in a certain asymmetric pattern. The asymmetric arrangement of the yarns in relation to the longitudinal direction of the sailcloth enables sails to be manufactured according to the cross-cut method. However, sails made according to this method cannot be said to be of optimum design with respect to stretching resistance and load carrying ability of the main load lines. In particular, the asymmetric arrangement of the reinforcing yarns makes it necessary during manufacture to turn the sailcloth over to achieve a configuration best suited to the main load lines. This is nevertheless problematic if the sailcloth's carrier layer and finishing layer do not coincide.

When making sails by adopting the cross-cut method especially the load bearing capacity of the sailcloth transversely to the machine direction is of great significance because the main load lines in the finished sail extend to a great extent vertically or deviate from perpendicular under an angle of less than 30° (in both directions). Only in the lower sail segment in the area of the sail foot do the main load lines of the sail diverge widely over an angular range of more than 30° in relation to the vertical, also in both directions. Essentially, the individual cross-cut segments of a sail have to be designed in terms of load bearing capacity such that they are capable of optimally absorbing the forces acting on the sail. On the other hand, the mass per unit of area of the sailcloth must not be increased too much through an excessive amount of reinforcing yarns integrated into the sail. In this respect a limiting the use of reinforcing yarns is essential.

When integrating reinforcing yarns into sailcloth additional problems are encountered in connection with the aging of yarn materials. In particular yarns containing fibers based on aromatic compounds tend to age when exposed to light and UV radiation. Yarns of this nature consist, for example, of aramids, aromatic polyamides and aromatic polyester. Polyolefin fibers, however, are outstandingly light resistant and their tendency towards aging is only slight for that reason, which also holds good for carbon fibers. Especially polyolefin fibers exhibit excellent stretching resistance but have a tendency for “creeping”, i.e. they become deformed under constant loading conditions.

Yarns having low expansion strength may break when exposed to sudden peak loads and thus bring the functionality of a sail down even to the point of uselessness. This problem becomes even more serious when yarns are used the aging stability of which is low. Moreover, if yarns fail that have low expansion strength and thus may easily break this results in sails into which they are incorporated to be lost. The same applies to carbon fibers, for example.

It is thus the objective of the invention to provide a sailcloth for the making of sails by adopting the cross-cut method, said cloth being optimally adapted to the main load lines of the completely manufactured sail. The sail shall meet the various requirements linked with service both in the regatta field and for recreation purposes, it shall be durable and have an appealing visual appearance.

Moreover, an additional objective of the invention is to provide sailcloth which is capable of lending to sails so-called emergency handling properties, that is ensures the functionality of a sail at a lower level in the event of yielding or failing yarns.

### SUMMARY OF THE INVENTION

This objective is achieved by providing sailcloth of the type first mentioned above, the intermediate layer of which consists of at least three layers of yarn laid at an angle ranging between 55 and 125° in relation to the machine direction so that at angles of 60° to 120° and 240° to 300° in relation to the longitudinal direction of the cloth the force at 1% of cloth expansion is not less than 150 Ibf (667 N).

The inventive sailcloth is manufactured on a customary machine by the meter and comprises a substrate or carrier layer, an intermediate layer and a finishing layer. The intermediate layer consists of several layers of laid yarn, at least three, preferably at least five. The laid yarns bring about reinforcement primarily transverse to the machine direction and within a layer extend in parallel strands at angles ranging between 55 and 125° in relation to the longitudinal direction. These yarns are preferably arranged at an angle of 55° to 70°, approximately 90° and 110 to 125° in relation to the longitudinal direction, i.e. 55° to 70°, 80° to 85°, 95° to 100° and 110° to 125°. As a rule, a parallel family of yarns extends in the machine direction)(0°).

The inventive arrangement of the reinforcing yarns in the range of 55 and 125° in relation to the longitudinal direction of the cloth causes the tensile strength of the cloth to increase, primarily transversely to the machine direction. Proceeding from the assumption yarn material, yarn count and yarn density are selected as appropriate and necessary the inventive value of the expansion strength of at least 150 Ibf (667 N) at 1% expansion can thus be reached in this area.

As a rule, a yarn layer is provided that extends in machine direction)(0°). Two additional yarn layers may also be provided the yarns of which are laid at an angle of 65 to 85° and 95 to 115° in relation to the longitudinal direction. These additional yarn layers preferably run at an angle of 75° and 115° in relation to the longitudinal direction. Especially advantageous are further yarn layers the yarns of which extending across a range of 20° to 40° and 140° to 160° in relation to the machine direction, in particular for use in the foot area of sails. In particular, such a cloth has an expansion strength of at least 100 Ibf (444 N) at 1% expansion.

Preferably, said yarns are arranged symmetrically to the longitudinal and transverse axis of the sailcloth, i. e. yarn pairs are achieved in this way at angles, for example, of 30°/150°, 60°/120°, 75/105° and 85°/95° in relation to the machine direction.

Sailcloth, the yarns of the individual yarn layers of which are arranged as aforesaid, being provided with additional yarn layers extending through 0° and 90° in relation to the longitudinal direction has a very high expansion strength both in the area of around 0° and around 90° in relation to the machine direction. It has been found that reinforcing yarns laid or extending adjacent to each other yield a more than proportional expansion strength, that is the tensile strength of the cloth definitely increases in the extension direction of a yarn due to yarn layers having slightly deviating extension characteristics. In this way a high strength of sails made according to the cross-cut method is achieved in the longitudinal direction of the sail enabling these sails to be adjusted precisely as wind conditions demand. Moreover, the maneuverability of a boat can thus be positively influenced.

Preferably, the expansion strength of the cloth in the range of 60° to 120° and 240° to 300° in relation to the longitudinal direction is not lower than 170 Ibf (765 N).

On the one hand, optimizing the expansion strength of the cloth transversely to the machine direction allows sails to be manufactured according to the cross-cut method and, additionally, satisfies wishes of yacht owners for sails which are as light as possible. Finishing sheets or film in the inventive sailcloth result in the sails being completely impermeable to wind and at the same time provide transparency and minimum water absorption. Since the woven fabrics are usually of plain weave design using textile fabrics as finishing layers yields additional reinforcement in the warp and weft direction of the fabric.

For sailmaking purposes, especially when high-performance sails are produced, it may be expedient to design the individual cross-cut segments or panels such that they meet the load requirements to be expected. Sailcloth that is to be arranged in the foot area may thus be provided with one or several additional yarn layers in the area of 20 to 40 and 140 to 160° in relation to the machine direction, in particular extending at 30° and 150° in relation to the machine direction. It may be useful for this purpose to replace the 90° yarns with yarns oriented at angles from 80° to 85° and 95° to 105°. This enables forces arising at the leech to be absorbed in the best possible manner. However, the other panels of the sail do not need such reinforcement in the area from 20 to 40 and 140 to 160°. As far as the orientation of the reinforcing yarns is concerned, a sail which is also suited for competition purposes can be made in this way by using only two types of sailcloth. Also important is that when making a sail according to the cross-cut method the number of seams required to connect the individual panels is limited which also contributes to reducing the weight.

For sailcloth manufacture yarns can usually be employed which are, for example, polyalkylene, polyester, polyamide yarns, especially polyethylene yarns known by the tradename of Spectra® and Dyneema®, as well as aramid fibers, for example Twaron® and Kevlar®. Furthermore, carbon fibers may also be employed.

It is of course also possible and of advantage to combine yarns of various kinds in each layer. For example, aside from aramid yarns or aromatic polyester or polyamide yarns having lower aging stability and lower expansion strength polyolefin fibers may be used which offer better properties in terms of expansion strength as well as aging stability. It will suffice in such a case to incorporate about 25 to 30% of yarns having high expansion strength and aging stability properties to make sure the sail can be safely handled in emergencies in case the other yarns fail in the event of peak loads or for age reasons. A failure of aramid yarns thus will not impair the sail's functionality altogether but instead just restrict its functionality to some extent so that the boat can be brought under minor load conditions to the next harbor or in any event enable the damaged sail to be safely recovered. Normally, the individual yarn types may be laid in the same adhesive bed but, alternatively, each yarn may of course be coated with an adhesive which may be especially suitable in a given case. In particular polyolefin yarns of high expansions strength could be used in this context to compensate for the poor breaking resistance of carbon yarns and such a yarn type combination may then be conducive to optimizing the strength properties also for sailing competition purposes.

To ensure emergency sail handling properties a proportion of up to 30% of yarns of high expansion strength made of polyolefins will be sufficient. Usually, a proportion ranging between 20 and 50% of the expensive, highly expansion and aging resistant polyolefin yarns is considered reasonable when providing such a mixed finish comprising two yarn types.

For the substrate or carrier layer woven fabric or sheet can be employed as is customarily used in sailcloth making. For the woven fabric particularly polyester fabric is suited but also mixed fabric, for example of polyester and polyethylene or polypropylene. For the sheets, polyester material, e.g. Mylar®, may expediently be used, with or without taffeta laminated to them.

Appropriately, the finishing layer consists of a polyester sheet, especially if the carrier sheet is made of woven fabric. Using sheet in this case makes sure the sail is impermeable to wind and allows the three layers to be bonded in the best possible way.

Expediently, the inventive sailcloth is a laminate comprising the three layers, i. e. the three layers are bonded and pressed together in such a manner that the yarns laid under pretension are firmly embedded. For this purpose, the yarns are best placed into a bed or layer of glue which makes sure the yarns are fixed/secured the moment they are laid. Besides, yarns coated with adhesive/glue which adhere to the substrate layer may also be used. Bonding of the individual layers may also be achieved or improved when the finished sailcloth is (additionally) subjected to a lamination process by means of which the individual layers are joined through the application of pressure and heat.

The parallelly oriented yarn strands in the individual yarn layers are expediently arranged at a spacing of between 4 and 20 mm. Said spacing depends on the strength requirements to be met as well as the yarn thickness itself, i. e. when yarns of high yarn count are used the space between the individual strands may be high and vice versa. The denier density of strands may, for example, be 18,000 dpi (denier per inch), said density may be composed of 18 strands each having an inch width of 1,000 den, six strands of an inch width of 3,000 den each or three strands of inch width of 6,000 den each.

As a rule, a strand denier density ranging between 2500 and 7500 dpi in each yarn layer will be sufficient, in particular a density of between 3000 and 6000 dpi. For yarn layers in which yarns are laid at angles ranging between 80° and 100° in relation to the machine direction, especially for 90° yarns, strand denier densities of up to 12000 dpi are considered useful, especially densities of 6000 to 10000 dpi.

The inventive sailcloth is supplied by the meter or in rolls and procured by the sailmaker in this form who then processes the cloth to produce the finished sail. Nevertheless, the invention also relates to sails manufactured from the inventive sailcloth, as well as the use of such sailcloth in propulsion and uplifting accessories of all kinds, e. g. sails, parachutes, balloon envelopes, glider wings, towing kites and the like.

### BRIEF DESCRIPTION OF THE DRAWINGS

The invention is explained in more detail by way of the enclosed figures where

FIG. 1 is a top view of a customary sail arrangement consisting of five sections with the principal stress or load lines indicated;

FIG. 2 illustrates an inventive sailcloth provided with reinforcing yarns laid between two sheets;

FIG. 3 is a polar diagram showing the stretching strength of the sailcloth variant illustrated in FIG. 2;

FIG. 4 is a representation of a sail composed of cross-cut panels;

FIG. 5 is the polar diagram of a sailcloth with reinforcing yarns extending between two film/taffeta finishing layers; and

FIG. 6 is the polar diagram of a known sailcloth with asymmetric distribution of the reinforcing yarns arranged between two sheets.

### DETAILED DESCRIPTION OF THE INVENTION

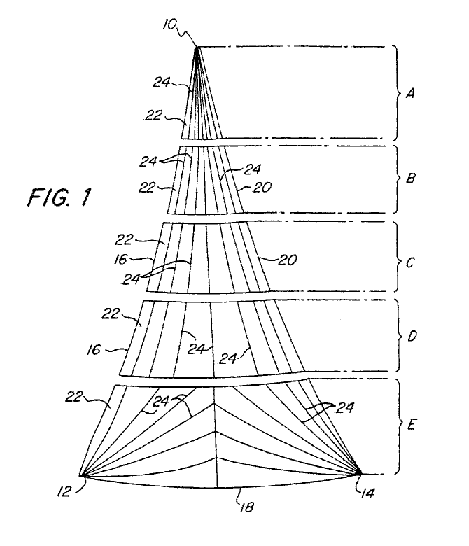

FIG. 1 shows as a top view five sections A to E before they are joined longitudinally at their abutting edges, for example by means of broad seams, to form a customary sail. The finished sail which is composed of five sections consists of head 10, tack 12, clew 14, luff 16, foot 18, and leech 20. The five sections A to E have a membrane 22 consisting of a sheet or film of high stretching resistance. Sheets of this kind are known per se. Examples here are drawn, aligned polyester sheets distributed, for example, under the tradename of Mylar®. Other sheets with high tensile module may be made of a polymer, e. g. nylon, polypropylene and similar material.

On the membrane 22 of each section A to E individual stress lines 24 are shown by way of examples. These stress lines correspond to the principal load or stress lines occurring when the composite sail is exposed to wind forces. Stress lines 24 should be followed by yarns consisting of multi-thread strands, cords or strips of stretch resistant polymer material, preferably an aramid, e. g. Kevlar.

FIG. 2 is a view that illustrates an inventive sailcloth section having a weight of 250 g/m². Between two polyester films individual Twaron® yarn layers are incorporated extending at angles of 0°, 60°, 75°, 90°, 105° and 120° in relation to the machine direction. The individual yarn layers are laid in a bed of glue and bonded to the carrier and finishing sheets of polyester with the aid of a lamination system under pressure and elevated temperature.

Data: 1610 dtex aramid fiber, 2×23 μm PET film

0°: 1 thread /cm=>3700 dpi

60°/120°: 1 thread each /cm=>3700 dpi

75°/105°: 1 thread each /cm=>3700 dpi

90°: 2 threads/cm=>7400 dpi

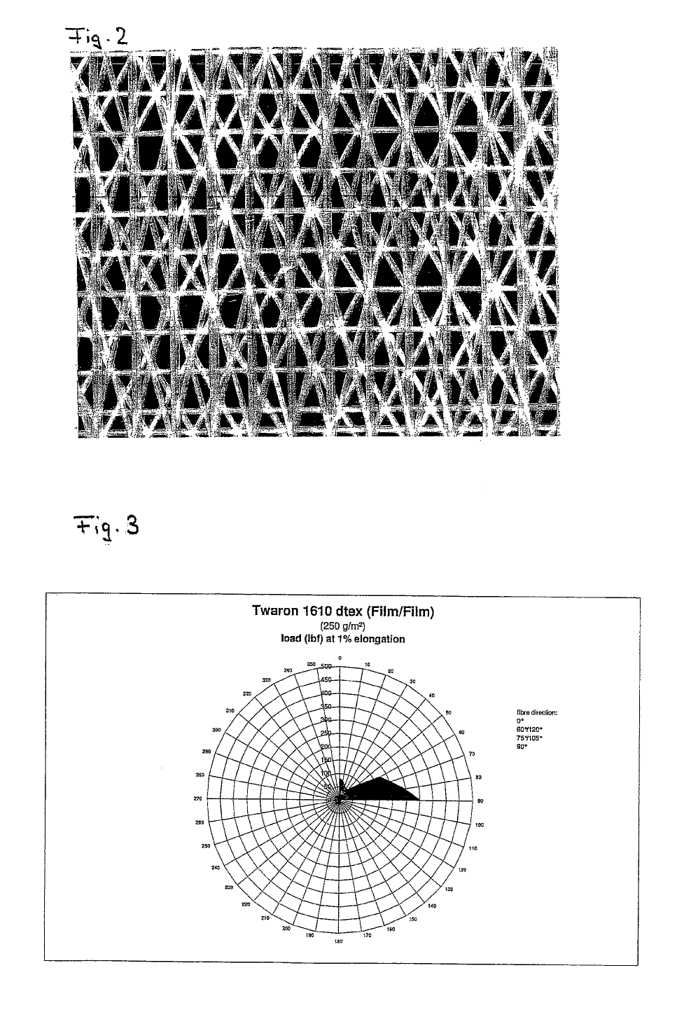

In FIG. 3 the stretching resistance or strength at 1% elongation is illustrated by way of a polar diagram depending on the angle relative to the machine direction of the sailcloth shown in FIG. 2. The load applied has been indicated in LBF. It can be seen that the sailcloth has a high stretching resistance over a range of 60° to 120° as well as 240 to 300° and a moderate load carrying ability over a range of 0 to 10°, 170 to 190° and 350 to 0°. The sailcloth is particularly suited for the manufacture of the upper panels of a main sail.

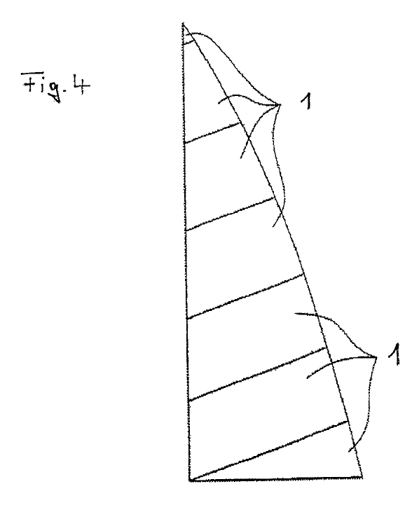

FIG. 4 shows a jib-headed sail (main sail) composed of individual sailcloth panels using the cross-cut technique, with the panels in this case not extending parallelly to the sail foot but for the main part perpendicular to the leech. From the arrangement shown it can be seen that the machine/longitudinal direction of the cloth extends perpendicularly to the leech.

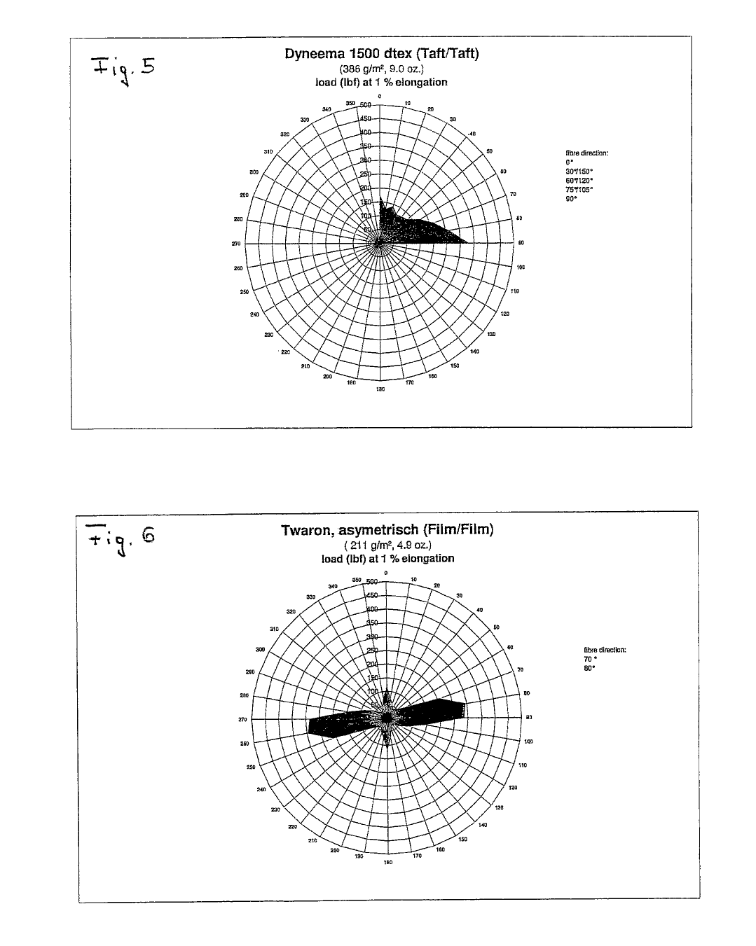

FIG. 5 is the polar diagram of a sailcloth the yarn layers of which being made of Dyneema (a polyolefin fiber) of a yarn count of 1,500 Ttex, said layers being arranged between two sheets onto which a lightweight taffeta fabric of polyester has been laminated. The sail has a mass per unit of area of 386 g/m². The yarn orientation is 0°, 30°, 60°, 75°, 90°, 105°, 120°, and 15020 in relation to the machine direction. It has been found that the stretching resistance was excellent across a range of 60 to 120° and 240 to 300° relative to the machine direction, but also in ranges of 0 to 60°, 120 to 240° and 300 to 0° . The sailcloth is well suited for the manufacture of panels arranged in parallel to the foot of a sail.

Data: 1500 dtex Dyneema, 2×23 μm PET film with taffeta (50×50)

0°: 1 thread /cm=>3400 dpi

60°/120°: 1 thread each /cm=>3400 dpi

75°/105°: 1 thread each /cm=>3400 dpi

30°/150°: 1 thread each /cm=>3400 dpi

90°: 2 threads/cm=>6800 dpi

In FIG. 6 the polar diagram of known sailcloth is shown in which Twaron yarns (aramid fibers) are placed in a bed of glue between two films. The fiber orientation is 0°, 70° and 80° .Although the stretching strength is good in the range of 020 and between 70 and 90° as well as 250 and 270° the cloth otherwise lacks strength in many areas. Sailcloth manufactured in this way is not very well suited for design of cross-cut sails because its stretching resistance is limited to a significant extent.

Data: 1610 dtex aramid fiber, 2×23 μm PET film

0°: 1 thread/cm=>3700 dpi

70°: 0.9 thread/cm=>3300 dpi

80°: 1.3 threads/cm=>4600 dpi

90°: 1.3 threads/cm=>4600 dpi

1. A sailcloth of longitudinal direction (machine direction) comprising a carrier layer, an intermediate layer with several plies of laid yarn as well as a finishing layer, with the yarns being bonded under pretension with the carrier layer and the layers joined with each other,
wherein
said intermediate layer consists of at least three yarn layers the yarns of which being laid at an angle ranging between 55 and 125° relative to the longitudinal direction so that at angles of 60° to 120° and 240° to 300° in relation to the longitudinal direction the cloth has a stretching resistance at 1% of expansion of at least 150 Ibf (667 N).

2. The sailcloth according to claim 1, characterized by yarn layers the yarns of which being laid at an angle of 0°, 55 to 70°, approx. 9020 and 110° to 125° in relation to the longitudinal direction.

3. The sailcloth according to claim 1, characterized by yarn layers the yarns of which being laid at an angle of 0°, 55 to 70°, 80 to 85°, 95 to 100° and 110° to 125° in relation to the longitudinal direction.

4. The sailcloth according to claim 1, characterized by two yarn layers the yarns of which being laid at an angle of 20° to 40° and 140° to 160° relative to the longitudinal direction.

5. The sailcloth according to claim 1, characterized by two yarn layers the yarns of which being laid at an angle of 70° to 80° and 100° to 120° relative to the longitudinal direction.

6. The sailcloth according to claim 1, characterized in that the yarn layers are arranged in pairs symmetrically to the transverse direction.

7. The sailcloth according to claim 1, characterized in that it contains yarns made of polyalkylene, polyester and/or polyamide.

8. The sailcloth according to claim 7, characterized in that it contains yarns made of aramid (Kevlar®, Twaron®) or polyester (Vectran®) in addition to those made of polyethylene (Dyneema®, Spectra®).

9. The sailcloth according to claim 1, wherein the carrier layer and/or finishing layer consist of a woven fabric.

10. The sailcloth according to claim 1, wherein the carrier layer and/or finishing layer consist of a sheet or film.

11. The sailcloth according to claim 1, in the form of a laminate.

12. The sailcloth according to claim 1, wherein said cloth contains yarn layers embedded in a layer of adhesive.

13. The sailcloth according to claim 1, wherein the individual yarn layers contain yarns arranged as parallel families at a spacing of between 4 and 20 mm.

14. The sailcloth according to claim 1, in the form of yard/meter goods or rolls.

15. A sail made of panels of sailcloth according to claim 1, manufactured by the cross-cut method.

16. The sail according to claim 15 with at least one sailcloth panel abutting on the sail foot.

17. Use of sailcloth according to claim 1, for the manufacture of propulsion and driving aids and accessories such as sails, wings of gliders, parachutes, balloon envelopes.
